(19) United States
(12) Patent Application Publication
(10) Pub. No.: US 2024/0318044 A1
(43) Pub. Date: Sep. 26, 2024

(54) SEALING TAPE FOR RECHARGEABLE LITHIUM BATTERY AND RECHARGEABLE LITHIUM BATTERY INCLUDING THE SAME

(71) Applicant: SAMSUNG SDI CO., LTD., Yongin-si (KR)

(72) Inventors: Ik Hwan CHO, Yongin-si (KR); Byeongdo KWAK, Yongin-si (KR); Changhee WOO, Yongin-si (KR); Jinhwan PARK, Yongin-si (KR)

(21) Appl. No.: 18/473,043

(22) Filed: Sep. 22, 2023

(30) Foreign Application Priority Data
Mar. 21, 2023 (KR) 10-2023-0036796
Aug. 24, 2023 (KR) 10-2023-0111555

(51) Int. Cl. C09J 7/24; C09J 7/25; C09J 7/29; C09J 133/14; H01M 50/586; H01M 50/595

(52) U.S. Cl. CPC C09J 7/24; C09J 7/255; C09J 7/29; C09J 133/14; H01M 50/586; H01M 50/595; C09J 2203/33; C09J 2433/00; C09J 2433/006; C09J 2467/006

(57) ABSTRACT

A sealing tape for a rechargeable lithium battery and a rechargeable lithium battery including the sealing tape are provided. The sealing tape includes a base layer and an adhesive layer on at least one surface of the base layer, wherein: the base layer comprises a first (meth)acrylic copolymer; the first (meth)acrylic copolymer comprises: a moiety derived from a first (meth)acrylate-based compound having a substituted or unsubstituted C1 to C20 alkyl group; a moiety derived from a second (meth)acrylate-based compound having a substituted or unsubstituted C3 to C20 cycloalkyl group; and a moiety derived from a third (meth)acrylate-based compound having a C1 to C20 alkyl group substituted with a phenoxy group; the adhesive layer comprises a second (meth)acrylic copolymer and a crosslinking agent; the second (meth)acrylic copolymer comprises: a moiety derived from a fourth (meth)acrylate-based compound having a substituted or unsubstituted C1 to C20 alkyl group.

### CROSS-REFERENCE TO RELATED APPLICATION

The present application claims priority to and the benefit of Korean Patent Application No. 10-2023-0036796, filed on Mar. 21, 2023, in the Korean Intellectual Property Office, and Korean Patent Application No. 10-2023-0111555, filed on Aug. 24, 2023, in the Korean Intellectual Property Office, the content of each of which in its entirety is herein incorporated by reference.

### BACKGROUND OF THE INVENTION

### 1. Field

One or more embodiments of the present disclosure relate to a sealing tape for a rechargeable lithium battery and a rechargeable lithium battery including the sealing tape.

### 2. Description of Related Art

Recently, rechargeable lithium batteries have drawn much attention as one or more suitable energy sources.

The rechargeable lithium batteries may be classified into either can-type (or kind) rechargeable lithium batteries or pouch-type (or kind) rechargeable batteries according to a battery case shape. In some embodiments, the can-type (or kind) rechargeable lithium batteries may be further classified into either cylindrical rechargeable lithium batteries or prismatic rechargeable lithium batteries.

The cylindrical rechargeable lithium batteries are manufactured by winding a stack of a positive electrode, a separator, and a negative electrode into a jelly roll-type (or kind) electrode assembly, housing the jelly roll-type electrode assembly in a cylindrical battery case, and then, sealing the cylindrical battery case.

In order to house the jelly roll-type electrode assembly in the cylindrical battery case, the jelly roll-type electrode assembly is manufactured to be smaller than the cylindrical battery case. Accordingly, a certain gap may be formed between the cylindrical battery case and the jelly roll-type electrode assembly.

However, because of the gap, the jelly roll-type electrode assembly may easily rotate or move inside the cylindrical battery case, deteriorating performance (such as internal resistance increase, electrode tab damage, etc.) of the rechargeable lithium batteries.

To address this issue, a ‘sealing tape’ for suppressing a movement (e.g., shift or flow) of the jelly roll-type or kind electrode assembly inside the cylindrical battery case has been proposed. The sealing tape is applied to the gap to attach the jelly roll-type electrode assembly to an inside wall of the cylindrical battery case and concurrently (e.g., simultaneously), fill the gap.

However, sealing tapes suitable in the related art may not overcome a decrease in adhesion strength over time and an isotropic volume change of the electrode assembly due to substantially continuous charging and discharging, and eventually if (e.g., when) internal/external vibration or impact occurs, the movement (e.g., shift or flow) of the jelly roll-type electrode assembly inside the cylindrical battery case may not be suppressed or reduced.

### SUMMARY

In a sealing tape according to aspects of one or more embodiments of the present disclosure, if (e.g., when) in contact with a fluid such as a liquid (e.g., an electrolyte solution), a three-dimensional shape capable of filling a gap may be realized by mutual balance between a force generated as a base layer expands and a fixing force of an adhesive layer. Additional aspect(s) may be set forth in part in the description which follows and, in part, will be apparent from the description, or may be learned by practice of the presented embodiments of the disclosure.

According to one or more embodiments of the present disclosure, a sealing tape for a rechargeable lithium battery includes a base layer and an adhesive layer on at least one surface of the base layer; wherein the base layer includes a first (meth)acrylic copolymer; and the adhesive layer includes a second (meth)acrylic copolymer and a crosslinking agent.

The sealing tape according to one or more embodiments overcomes a decrease in adhesion strength over time and an isotropic volume change of the electrode assembly due to substantially continuous charging and discharging, and/or the like, even if internal/external vibration or shock occurs, the sealing tape may suppress or reduce a jelly roll-type (or kind) electrode assembly from flowing (e.g., shifting) inside the cylindrical battery case.

Accordingly, in a rechargeable lithium battery in which the sealing tape according to one or more embodiments is applied to a gap between a cylindrical battery case and a jelly roll electrode assembly, an increase in internal resistance, damage to the electrode tab, etc. are suppressed or reduced, and excellent or suitable performance may be maintained.

### BRIEF DESCRIPTION OF THE DRAWINGS

The accompanying drawing is included to provide a further understanding of the present disclosure, and is incorporated in and constitutes a part of this specification. The drawing illustrates example embodiments of the present disclosure and, together with the description, serve to explain principles of present disclosure.

FIG. 1 is a schematic view showing a sealing tape 200 according to some embodiments of the present disclosure.

FIG. 2 is a schematic view showing how a sealing tape 200 according to some embodiments is deformed while in contact with a fluid.

FIG. 3 is a drawing that structurally illustrates a polymer of a semi-interpenetrating polymer network (semi-IPN) structure according to one or more embodiments of the present disclosure.

FIG. 4 is a schematic view showing a rechargeable lithium battery according to one or more embodiments of the present disclosure.

### DETAILED DESCRIPTION OF THE EMBODIMENTS

The present disclosure may be modified in many alternate forms, and thus specific embodiments will be exemplified in the drawing and described in more detail. It should be understood, however, that it is not intended to limit the present disclosure to the particular forms disclosed, but rather, is intended to cover all modifications, equivalents, and alternatives falling within the spirit and scope of the present disclosure.

Hereinafter, specific embodiments will be described in more detail so that those of ordinary skill in the art may easily implement them. However, the present disclosure may be embodied in many different forms and is not construed as limited to the example embodiments set forth herein.

The terminology utilized herein is utilized to describe embodiments only, and is not intended to limit the present disclosure. The singular expression includes the plural expression unless the context clearly dictates otherwise.

As utilized herein, “a combination thereof” refers to a mixture, a laminate, a composite, a copolymer, an alloy, a blend, a reaction product, and/or the like of constituents.

Herein, it should be understood that terms such as “comprise(s),” “include(s),” or “have/has” are intended to designate the presence of an embodied feature, number, step, element, or a combination thereof, but it does not preclude the possibility of the presence or addition of one or more other features, number, step, element, or a combination thereof.

In the drawings, the thickness of layers, films, panels, regions, etc., may be exaggerated for clarity, and like reference numerals designate like elements throughout the present disclosure, and duplicative descriptions thereof may not be provided for conciseness. It will be understood that when an element such as a layer, film, region, or substrate is referred to as being “on” another element, it may be directly on the other element or intervening elements may also be present. In contrast, when an element is referred to as being “directly on” another element, there are no intervening elements present.

In some embodiments, “layer” herein includes not only a shape formed on the whole surface when viewed from a plan view, but also a shape formed on a partial surface.

As utilized herein, if (e.g., when) a definition is not otherwise provided, “substituted” refers to replacement of at least one hydrogen of a substituent or a compound by a substituent selected from a halogen (F, Cl, Br, or I), a hydroxy group, C1 to C20 alkoxy group, a nitro group, a cyano group, an amine group, an imino group, an azido group, an amidino group, a hydrazino group, a hydrazono group, a carbonyl group, a carbamoyl group, a thiol group, an ester group, an ether group, a carboxyl group or a salt thereof, a sulfonic acid group or a salt thereof, a phosphoric acid or a salt thereof, a C1 to C20 alkyl group, a C2 to C20 alkenyl group, a C2 to C20 alkynyl group, a C6 to C30 aryl group, a C3 to C20 cycloalkyl group, a C3 to C20 cycloalkenyl group, a C3 to C20 cycloalkynyl group, a C2 to C20 heterocycloalkyl group, a C2 to C20 heterocycloalkenyl group, a C2 to C20 heterocycloalkynyl group, and/or a combination thereof.

As utilized herein, if (e.g., when) a definition is not otherwise provided, the term “cycloalkyl” includes “monocycloalkyl” and/or “bicycloalkyl”, wherein “bicycloalkyl” is a fused, spiro, or bridged bicyclic hydrocarbon.

As utilized herein, if (e.g., when) a definition is not otherwise provided, the terms “heterocycloalkyl group,” “heterocycloalkenyl group,” “heterocycloalkynyl group,” and “heterocycloalkylene group” refer to cycloalkyl, cycloalkenyl, cycloalkynyl, and cycloalkylene in which at least one N, O, S, or P heteroatom exists in the cyclic compound, respectively.

As utilized herein, if (e.g., when) a definition is not otherwise provided, the term “(meth)acrylate” refers to both (e.g., simultaneously) “acrylate” and/or “methacrylate.”

As utilized herein, if (e.g., when) a definition is not otherwise provided, the term “combination” refers to mixing or copolymerization. Further, “copolymerization” refers to a block copolymerization or a random copolymerization, and “copolymer” refers to a block copolymer or a random copolymer.

In the chemical formula of the present disclosure, unless a definition is otherwise provided, hydrogen is boned at the position when a chemical bond is not drawn where supposed to be given.

As utilized herein, if (e.g., when) a definition is not otherwise provided, “*” indicates a point where the same or different atom or chemical formula/moiety is linked.

In the present disclosure, the term “moiety” refers to a certain part or unit derived from a specific compound when a specific compound participates in a chemical reaction and is included in a polymerization reaction product. For example, in a first (meth)acrylic copolymer, the “moiety” derived from a first compound refers to a certain part or unit derived from the first compound.

“Thickness” may be measured through an image taken with an optical microscope such as a scanning electron microscope.

### Sealing Tape

In One or more embodiments, a sealing tape for a rechargeable lithium battery may include a base layer and an adhesive layer on at least one surface of the base layer, wherein the base layer may include a first (meth)acrylic copolymer, and the adhesive layer may include a second (meth)acrylic copolymer and a crosslinking agent.

The first (meth)acrylic copolymer may include a moiety derived from a first (meth)acrylate-based compound having a substituted or unsubstituted C1 to C20 alkyl group; a moiety derived from a second (meth)acrylate-based compound having a substituted or unsubstituted C3 to C20 cycloalkyl group; and a moiety derived from a third (meth)acrylate-based compound having a C1 to C20 alkyl group substituted with a phenoxy group.

In one or more embodiments, the second (meth)acrylic copolymer may include a moiety derived from a fourth (meth)acrylate-based compound having a substituted or unsubstituted C1 to C20 alkyl group.

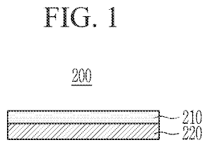

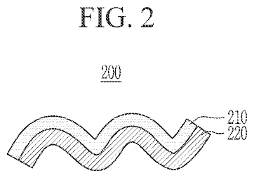

FIG. 1 is a schematic view illustrating a sealing tape 200 according to one or more embodiments or present disclosure; and FIG. 2 is a schematic view showing the deformation of a sealing tape 200 according to one or more embodiments in a state of contact with a fluid. Hereinafter, a sealing tape 200 according to one or more embodiments will be described with reference to FIG. 1 and FIG. 2.

As shown in FIG. 1, the sealing tape 200 according to one or more embodiments may include a base layer 220 and an adhesive layer 210 on at least one surface of the base layer 220.

(1) In the sealing tape 200 according to one or more embodiments, the base layer 220 may include the first (meth)acrylic copolymer, so that it may swell when in contact with an electrolyte solution, which is a type or kind of fluid.

(2) In the sealing tape 200 according to one or more embodiments, the adhesive layer 210 may include the second (meth)acrylic copolymer and the crosslinking agent, so that it has excellent or suitable adhesion strength even if (e.g., when) in contact with an electrolyte solution, which is a type or kind of fluid.

Therefore, as shown in FIG. 2, if (e.g., when) the sealing tape 200 according to one or more embodiments contacts a fluid, a mutual balance between a force generated as the base layer expands and a fixing force of the adhesive layer may be achieved, it may implement a three-dimensional shape that can fill a gap.

As a result, the sealing tape 200 according to one or more embodiments overcomes a decrease in adhesion strength over time and an isotropic volume change of the electrode assembly due to substantially continuous charging and discharging, and/or the like, even if internal/external vibration or shock occurs, it may suppress or reduce a jelly roll-type or kind electrode assembly from flowing (e.g., shifting) inside the cylindrical battery case.

In one or more embodiments, in a rechargeable lithium battery in which the sealing tape according to one or more embodiments is applied to a gap between a cylindrical battery case and a jelly roll electrode assembly, an increase in internal resistance, damage to the electrode tab, etc. are suppressed or reduced, and excellent or suitable performance may be maintained.

Hereinafter, a sealing tape according to one or more embodiments will be described in more detail.

### Base Layer

The base layer may swell upon contact with an electrolyte solution by including the first (meth)acrylic copolymer.

For example, in one or more embodiments, a strain rate of the base layer may be greater than or equal to about 50%, greater than or equal to about 60%, greater than or equal to about 70%, or greater than or equal to about 75%, and less than or equal to about 150%, less than or equal to about 130%, less than or equal to about 100%, or less than or equal to about 95% when impregnated with an electrolyte solution at 25° C. for 120 minutes or more and 1 day or less, and the strain rate utilized herein may refer to Equation 1. In some embodiments, a composition of the electrolyte solution may include ethylene carbonate (EC), propylene carbonate (PC), and/or dimethyl carbonate (DMC). In some embodiments, the electrolyte solution may include 1.1 M LiPF₆ dissolved in a solvent in which ethylene carbonate (EC), dimethyl carbonate (DMC), propylene carbonate (PC), and fluorobenzene (FB) are mixed in a volume ratio of EC:DMC:PC:FB=30:55:5:10:

$$( B - A ) / A \qquad Equation 1$$

wherein, in Equation 1, A is a length in a specific direction of the base layer before impregnation with an electrolyte solution; and B is a specific direction length of the base layer after impregnation with an electrolyte solution.

If (e.g., when) the strain rate upon impregnation of the base layer with the electrolyte solution is less than the above range, the jelly roll-type or kind electrode assembly may be loosened during a subsequent process, whereas if (e.g., when) it exceeds the above range, the diameter of the electrode assembly increases, making it difficult to insert into the cylindrical battery case.

For example, in one or more embodiments, strain measurement conditions if (e.g., when) the base layer is impregnated with an electrolyte solution are as follows. A specimen is manufactured by cutting the base layer to have a width*length=10 mm*10 mm, and the strain rate may be evaluated by Equations 1-1 and 1-2 in the longitudinal direction and width direction of the specimen, respectively:

$$Equation 1 - 1$$

$$Strain rate in a longitudinal direction = ( L 2 - L 1 ) / L 1 \times 100$$

In Equation A, L1 is a length in a length (longitudinal) direction of the specimen measured before impregnation with the electrolyte solution, that is, 10 mm; and L2 is a length in the length (longitudinal) direction of the specimen measured after impregnation with the electrolyte solution.

$$Strain rate in a width direction = ( W 2 - W 1 ) / W 1 \times 100 \qquad Equation 1 - 2$$

In Equation B, W1 is a breadth (or length) in a width (horizontal or transverse) direction of the specimen measured before impregnation with the electrolyte solution, that is, 10 mm; W2 is a breadth (or length) in the width (horizontal) direction of the specimen measured after impregnation with the electrolyte solution.

The high strain rate (swelling rate) of the base layer upon impregnation with the electrolyte solution may be caused by the first (meth)acrylic copolymer constituting the base layer.

For example, in one or more embodiments, the first (meth)acrylic copolymer may include a moiety derived from a first (meth)acrylate-based compound having a substituted or unsubstituted C1 to C20 alkyl group; a moiety derived from a second (meth)acrylate-based compound having a substituted or unsubstituted C3 to C20 cycloalkyl group; and a moiety derived from a third (meth)acrylate-based compound having a C1 to C20 alkyl group substituted with a phenoxy group.

Because the first (meth)acrylic copolymer includes the aforementioned moieties, at least a portion of the base layer may contact the electrolyte solution to exhibit adhesion strength.

Accordingly, if (e.g., when) the sealing tape of some embodiments is applied to the gap, if (e.g., when) the base layer is placed in contact with the cylindrical battery case and then the electrolyte solution is injected, at least a portion of the base layer is formed in contact with the inner wall of the cylindrical battery case and being in contact with each other, a gap may be filled while attaching the jelly roll-type or kind electrode assembly to the inner wall of the cylindrical battery case.

The moieties constituting the first (meth)acrylic copolymer will be described later, and the structure of the base layer will be described.

In one or more embodiments, the base layer may further include a polyethylene terephthalate (PET) film, and in these embodiments, mechanical strength of the sealing tape of one or more embodiments may be increased.

For example, in one or more embodiments, the base layer may be obtained by interposing a first (meth)acrylic copolymer film including the first (meth)acrylic copolymer between two PET films. In some embodiments, the base layer may include a first base layer including a first PET film; a second base layer including the first (meth)acrylic copolymer; and a third base layer including a second PET film which are sequentially stacked.

in one or more embodiments, a total thickness of the base layer may be about 5 to about 150 μm; in some embodiments, a thickness ratio of the first base layer: the second base layer may be about 1:9 to about 9:1; and a thickness ratio of the third base layer: the second base layer may be about 1:9 to about 9:1.

### Adhesive Layer

By including the second (meth)acrylic copolymer and the crosslinking agent, the adhesive layer not only has excellent or suitable initial adhesion strength, but also suppresses deterioration of adhesion strength over time, and maintains excellent or suitable adhesion strength even if (e.g., when) in contact with the electrolyte solution.

For example, in one or more embodiments, if (e.g., when) the adhesive layer is peeled at a peel angle of 180 degrees, a peel force may be greater than about 400 N/cm, greater than or equal to about 450 N/cm, greater than or equal to about 500 N/cm, or greater than or equal to about 550 N/cm; and less than or equal to about 1,000 N/cm, less than or equal to about 900 N/cm, less than or equal to about 800 N/cm, less than or equal to about 700 N/cm, or less than or equal to about 650 N/cm.

For example, in order to measure the peel force of the adhesive layer, a specimen is prepared by cutting a sealing tape of one or more embodiments such that a horizontal length is 25 mm and a vertical length is 200 mm. The adhesive layer side of the specimen is attached to a glass plate utilizing a 2 kg rubber roller, and stored at room temperature for about 2 hours. Thereafter, the peel force is measured while peeling at a peeling speed of 5 mm/sec and a peeling angle of 180 degrees utilizing a tensile tester.

The excellent or suitable adhesion strength of the adhesive layer may be caused by the second (meth)acrylic copolymer constituting the base layer.

For example, in one or more embodiments, the second (meth)acrylic copolymer may include a moiety derived from a fourth (meth)acrylate-based compound having a substituted or unsubstituted C1 to C20 alkyl group.

The moiety constituting the second (meth)acrylic copolymer will be described later, and structures formed by the second (meth)acrylic copolymer and the crosslinking agent in the adhesive layer will be described.

In the adhesive layer, a portion of the second (meth)acrylic copolymer may be crosslinked by the crosslinking agent to form a polymer having a semi-interpenetrating polymer network (semi-IPN) structure.

The adhesive layer may include a network structure polymer formed by crosslinking the second (meth)acrylic copolymer with the crosslinking agent; and a linear polymer including the second (meth)acrylic copolymer, independently of the network structure polymer.

In some embodiments, in the adhesive layer 200, a portion of the (meth)acrylic copolymer may be crosslinked by the crosslinking agent to form a polymer having a semi-interpenetrating polymer network (semi-IPN) structure.

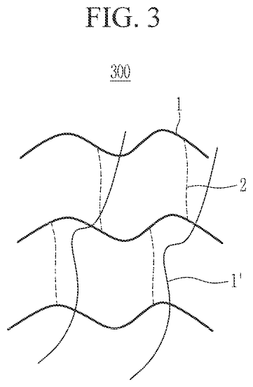

For example, as shown in FIG. 3, a polymer 300 of the semi-interpenetrating polymer network (semi-IPN) structure, in which a (meth)acrylic copolymer 1 may be crosslinked by a crosslinking agent 2, may include a network structure polymer formed by crosslinking the (meth)acrylic copolymer 1 with the crosslinking agent 2; and independently of the network structure polymer, a linear polymer including a (meth)acrylic copolymer 1′.

If (e.g., when) the (meth)acrylic copolymer 1 is crosslinked by the crosslinking agent 2 to form the polymer 300 having a semi-IPN structure, in the embodiment in which the (meth)acrylic copolymer 1 and the crosslinking agent 2 exist independently (e.g., are blended), adhesion strength, mechanical properties, chemical resistance, expandability when impregnated with an electrolyte solution, etc. may be improved compared with the embodiment in which only one of the above two materials is present.

In one or more embodiments, a crosslinking degree of the adhesive layer may be about 85 to about 98%. Herein, the crosslinking degree may be confirmed by a gel fraction (gel contents). If (e.g., when) the crosslinking degree of the adhesive layer is less than about 85%, the adhesive layer may be swollen and dispersed. In contrast, if (e.g., when) the crosslinking degree of the adhesive layer exceeds about 98%, the adhesive layer may have too high a stiffness.

The crosslinking degree (gel fraction) of the adhesive layer may be measured by the following method.

A weighed sample (weight: 1 g) is added in a 20 mL vial into a wire mesh bag having 200 meshes, 1,2,4-trichlorobenzene (about 10 mL) is added enough to submerge the sample, and is heated at 130° C. for 2 hours or more. Thereafter, the undissolved components not filtered through the wire mesh having 200 meshes are washed twice in a xylene solution, and then dried in a hot air oven at 120° C. for 12 hours. Finally, dry undissolved components are weighed (weight: W mg), and calculated utilizing Equation 2:

$$Gel fraction ( \% ) = ( W / WO ) \times 100 , \qquad Equation 2$$

wherein, in Equation 2, W is a weight of the dried undissolved component; and WO is a weight of the weighted sample, that is, 1 g.

In one or more embodiments, a thickness of the adhesive layer is not particularly limited, and an adhesive layer of about 5 to about 150 μm may be formed.

### First (Meth)acrylic Copolymer and Second (Meth)acrylic Copolymer

Both of the first (meth)acrylic copolymer and the second (meth)acrylic copolymer are excellent or suitable in adhesion strength, mechanical properties, chemical resistance, expandability if (e.g., when) impregnated with an electrolyte solution, and/or the like.

In some embodiments, both (e.g., simultaneously) of the first (meth)acrylic copolymer and the second (meth)acrylic copolymer may be acid-free (e.g., may exclude an acid). If (e.g., when) an acid (e.g., an organic acid) is included in the adhesive layer, a complex may be formed between the carboxyl group of the acid and the lithium cation (Lit) of the electrolyte solution, which may adversely affect the efficiency and cycle-life of the battery.

Because both of the first (meth)acrylic copolymer and the second (meth)acrylic copolymer (e.g., they simultaneously) do not contain an acid component such as (meth)acrylic acid, an acid value thereof may be less than or equal to about 1 mgKOH/g, less than or equal to about 0.5 mgKOH/g, or less than or equal to about 0.3 mgKOH/g. In one or more embodiments, the lower limit may be closer to 0 mgKOH/g, and may be greater than or equal to about 0.05 mgKOH/g, or greater than or equal to about 0.1 mgKOH/g.

However, if (e.g., when) acid-free, the electrode assembly may be loosened before or after being housed in the battery case due to poor adhesion to metal and/or the like.

In order to address this issue, moieties derived from polar monomer compounds are required and desired, and in one or more embodiments, moieties corresponding to the polar monomer compounds may be included.

Moiety Derived from First Compound and Moiety Derived from Fourth Compound

The first (meth)acrylic copolymer may include a moiety derived from a first compound (e.g., a first (meth)acrylate-based compound), and the second (meth)acrylic copolymer may include a moiety derived from a fourth compound (e.g., a fourth (meth)acrylate-based compound).

The moiety derived from the first compound refers to a portion derived from the first compound when the first compound undergoes a chemical reaction (e.g., polymerization) to form the first (meth)acrylic copolymer. Hereinafter, the same applies to the moieties derived from the second to fourth compounds.

The first compound and the fourth compound may each independently be a substituted or unsubstituted C1 to C20 alkyl (meth)acrylate-based compound.

For example, in one or more embodiments, the first compound and fourth compound may each independently be hydroxyethyl (meth)acrylate, 2-hydroxypropyl (meth)acrylate, 4-hydroxybutyl (meth)acrylate, 2-ethylhexyl (meth)acrylate, methyl (meth)acrylate, ethyl (meth)acrylate, propyl (meth)acrylate, butyl (meth)acrylate, pentyl (meth)acrylate, hexyl (meth)acrylate, heptyl (meth)acrylate, octyl (meth)acrylate, nonyl (meth)acrylate, decyl (meth)acrylate, dodecyl (meth)acrylate, lauryl (meth)acrylate, and/or the like, but embodiments of the present disclosure are not necessarily limited thereto. These may be applied alone or in combination of two or more. Herein, (meth)acrylate refers to both (e.g., simultaneously) acrylate and/or methacrylate.

For example, in some embodiments, the first compound may be 2-hydroxyethyl acrylate.

In one or more embodiments, based on a total amount of 100 wt % of the first (meth)acrylic copolymer, the moiety derived from the first compound may be included in an amount of about 20 to about 50 wt %, about 25 wt % to about 45 wt %, or about 30 wt % to about 40 wt %.

Within these ranges, no vapor or floating occurs under heat-resistant and moisture-resistant conditions, and the first (meth)acrylic copolymer have excellent or suitable durability characteristics.

For example, in some embodiments, the fourth compound may be a combination of 2-hydroxyethyl acrylate and 4-hydroxybutyl acrylate.

In one or more embodiments, based on a total amount of 100 wt % of the second (meth)acrylic copolymer, the moiety derived from the fourth compound may be included in an amount of about 100 wt %. Within the range, no vapor or floating occurs under heat-resistant and moisture-resistant conditions, and the second (meth)acrylic copolymer have excellent or suitable durability characteristics.

Moiety Derived from Second Compound

The first (meth)acrylic copolymer may include a moiety derived from a second compound (e.g., a second (meth)acrylate-based compound).

The second compound may be a substituted or unsubstituted C3 to C20 cycloalkyl (meth)acrylate-based compound.

For example, in one or more embodiments, the second compound may include isobornyl (meth)acrylate, bornyl (meth)acrylate, cyclohexyl (meth)acrylate, and/or the like, but embodiments of the present disclosure are not necessarily limited thereto. These may be applied alone or in a mixture of two or more.

In one or more embodiments, based on a total amount of 100 wt % of the first (meth)acrylic copolymer, moiety derived from the second compound may be included in an amount of about 30 to about 70 wt %, about 35 wt % to about 65 wt %, or about 40 to about 60 wt %. Durability of the first (meth)acrylic copolymer is improved in the above range, and initial adhesion strength thereof may be secured.

Moiety Derived from Third Compound

The first (meth)acrylic copolymer may include a moiety derived from a third compound (e.g., a third (meth)acrylate-based compound).

The third compound may be (meth)acrylate-based compounds having a C1 to C20 alkyl group substituted with a phenoxy group.

For example, in one or more embodiments, the third compound may be phenoxyethyl acrylate.

### Physical Properties of First (Meth)acrylic Copolymer and Second (Meth)acrylic Copolymer

The first (meth)acrylic copolymer and the second (meth)acrylic copolymer may each independently have a weight average molecular weight of about 500,000 to about 3,000,000 g/mol. Adhesion strength and durability thereof are excellent or suitable in the above range. The weight average molecular weight may be measured utilizing gel permeation chromatography (GPC).

The first (meth)acrylic copolymer and the second (meth)acrylic copolymer each independently have a glass transition temperature (Tg) of—about 40° C. to about −5° C., for example about −30° C. to about −10° C. Workability is excellent or suitable in the above range, and durability or adhesion of the first (meth)acrylic copolymer and second (meth)acrylic copolymer is excellent or suitable. The glass transition temperature may be measured utilizing differential scanning calorimetry (DSC) equipment (TA Instrument).

### Crosslinking Agent

Regarding the crosslinking agent, as a crosslinking agent capable of being cured with active energy rays, an isocyanate-based compound that may form a polymer of a semi-interpenetrating polymer network (semi-IPN) structure by curing is the fourth compound, an isocyanurate-based compound, or combinations thereof may be used.

The isocyanate-based compound may be a trimethylolpropane (TMP) adduct type. For example, in some embodiments, as the isocyanate-based compound, trimethylolpropane-toluene diisocyanate (TMP-TDI) adduct and/or trimethylolpropane-xylylene diisocyanate (TMP-XDI) may be added.

As the isocyanurate-based compound, tris[2-(acryloyloxy)ethyl] isocyanurate may be utilized.

In one or more embodiments, in the adhesive layer, a content (e.g., amount) of the crosslinking agent may be about 0.01 to about 5 parts by weight, about 0.03 to about 4 parts by weight, or about 0.05 to about 3 parts by weight, based on 100 parts by weight of the second (meth)acrylic copolymer. Within this range, a semi-IPN structure can be stably formed.

### Manufacturing Method of Base Layer

For example, the base layer including the first (meth)acrylic copolymer may be manufactured by the following method.

A first mixture including the first to third compounds is prepared, a first photoinitiator is added, and then ultraviolet (UV) light is irradiated at an intensity of 100 to 500 mJ/cm² to form a latex type first (meth)acrylic copolymer resin. A composite resin is thus prepared. A second mixture may be prepared by mixing the first (meth)acrylic copolymer resin with a second photoinitiator and a curing agent. After applying the second mixture on the first PET film, covering the second PET film, and curing the second mixture by irradiating ultraviolet (UV) with an intensity of 1000 to 5000 mJ/cm², a base layer may be obtained.

The first photoinitiator and the second photoinitiator may each independently be activated by ultraviolet light or an electron beam to activate a carbon-carbon double bond in the base layer to generate a radical reaction. As specific examples, an alpha-hydroxy ketone type compound, a benzyl ketal type compound, or a mixture thereof may be used, but embodiments of the present disclosure are not limited thereto. For example, the first and second photoinitiators may each independently be an alpha-hydroxy ketone type compound, for example, in some embodiments, 1-hydroxy-cyclohexyl-phenyl-ketone, 2-hydroxy 2-methyl-1-phenyl-1-propanone, 2-hydroxy-1-[4-(2-hydroxyethoxy)phenyl]-2-methyl-1-propanone and/or the like may be utilized. The photoinitiators may be used alone or in combination of two or more.

The first photoinitiator may be applied in an amount of 0.001 to 3 parts by weight, for example 0.003 to 1 part by weight, based on 100 parts by weight of the first mixture.

In addition, the second photoinitiator may be applied in an amount of 0.001 to 3 parts by weight, for example 0.003 to 1 part by weight, based on 100 parts by weight of the first (meth)acrylic copolymer resin.

Low light leakage and excellent durability reliability may be obtained within the above range.

### Manufacturing Method of Adhesive Layer

For example, a method for preparing an adhesive layer including the second (meth)acrylic copolymer and a crosslinking agent may be as follows.

After adding a thermal initiator and a solvent to the fourth compound, partial polymerization may be performed to produce a second (meth)acrylic copolymer in the form of an oligomer. A fifth mixture may be prepared by mixing the second (meth)acrylic copolymer with a fifth isocyanate-based compound and a silane-based coupling agent as a crosslinking agent. The fifth mixture is applied to one side of a release film (for example, a PET film treated with a silicone-based release agent), dried at 100 to 150° C. for 1 to 10 minutes, and then separated from the release film to obtain an adhesive layer.

As the thermal initiator, 2,2′-azobisisobutyronitrile may be used.

The thermal initiator may be applied in an amount of 0.001 to 3 parts by weight, for example 0.003 to 1 part by weight, based on 100 parts by weight of the second (meth)acrylic copolymer. In this range, excellent durability reliability may be obtained.

A mixture of ethyl acetate and toluene may be used as the solvent.

In one or more embodiments, a sixth mixture may be prepared by adding a sixth isocyanurate-based compound and a third photoinitiator as a crosslinking agent to the second (meth)acrylic copolymer prepared in the same manner as described above.

The sixth mixture is applied to one side of a release film (for example, a PET film treated with a silicone-based release agent), and cured by irradiating ultraviolet (UV) with an intensity of 1000 to 5000 mJ/cm². it may obtain an adhesive layer by separating from the release film.

The third photoinitiator is activated by ultraviolet rays or electron beams to activate a carbon-carbon double bond in the adhesive layer to cause a radical reaction. As specific examples, an alpha-hydroxy ketone type compound, a benzyl ketal type compound, or a mixture thereof may be used, but embodiments of the present disclosure are not limited thereto. For example, the third photoinitiator may be an alpha-hydroxy ketone type compound, for example, in some embodiments, 1-hydroxy-cyclohexyl-phenyl-ketone, 2-hydroxy 2-methyl-1-phenyl-1-propanone, 2-hydroxy-1-[4-(2-hydroxyethoxy)phenyl]-2-methyl-1-propanone and the like may be used. The photoinitiators may be used alone or in combination of two or more.

The third photoinitiator may be applied in an amount of 0.001 to 3 parts by weight, for example 0.003 to 1 part by weight, based on 100 parts by weight of the second (meth)acrylic copolymer.

Low light leakage and excellent durability reliability may be obtained within the above range.

### Width of Sealing Tape

A width of the sealing tape of one or more embodiments may be at least about 20% of a width of the electrode assembly.

The sealing tape of one or more embodiments may have a peel force of at least about 150 gf/cm (T-Peel peeling 300 mm/min, 10 μm negative electrode/PSA/10 μm negative electrode). If (e.g., when) it is 150 gf or less, the jelly roll-type or kind electrode assembly may be loosened during a subsequent process.

### Rechargeable Lithium Battery

In one or more embodiments, a rechargeable lithium battery may include an electrode assembly; an electrolyte solution impregnated in the electrode assembly; the sealing tape of one or more of the aforementioned embodiments attached to at least a portion of an inside of the electrode assembly; and a battery case accommodating the electrode assembly.

In one or more embodiments, the electrode assembly may be a winding type or kind electrode assembly, for example, a jelly roll electrode assembly.

For example, in one or more embodiments, the electrode assembly may be formed by sequentially stacking a first electrode, a separator, and a second electrode and then winding them.

In one or more embodiments, the sealing tape of one or more embodiments may be attached to at least a portion of the inside of the electrode assembly to reduce a gap between an inner wall of the battery case and the electrode assembly and to fix the electrode assembly.

For example, in one or more embodiments, a portion of the sealing tape may be exposed as an outermost layer of the electrode assembly. After the electrode assembly is placed inside the battery case, the sealing tape is attached to the inside of the outermost layer of the electrode assembly and expands when impregnated with a fluid (e.g., electrolyte solution), thereby indirectly minimizing or reducing the gap between the inner wall of the battery case and the electrode assembly, while exhibiting vibration resistance and shock resistance.

In one or more embodiments, the electrolyte solution may include a carbonate-based solvent, and the carbonate-based solvent may include at least one carbonate-based solvent selected from ethylene carbonate (EC), propylene carbonate (PC), ethylmethyl carbonate (EMC), dimethyl carbonate (DMC), diethyl carbonate (DEC), and dipropyl carbonate (DPC). For example, in some embodiments, the carbonate-based solvent is ethylene carbonate (EC) or dimethyl carbonate (DMC) and propylene carbonate (PC).

In some embodiments, the electrolyte solution may further include fluorobenzene (FB).

The electrolyte solution may include about 50 to about 99 wt %, about 60 wt % to about 95 wt %, or about 80 wt % to about 90 wt % of the carbonate-based solvent, and about 50 wt % to about 99 wt %, about 60 wt % to about 95 wt %, or about 80 wt % to about 90 wt % of the fluorobenzene (FB) based on 100 wt % of a total weight of the electrolyte solution.

If (e.g., when) the circumferential length of an outer surface of the electrode assembly is considered to be 1, the sealing tape may have a length smaller than about 0.5.

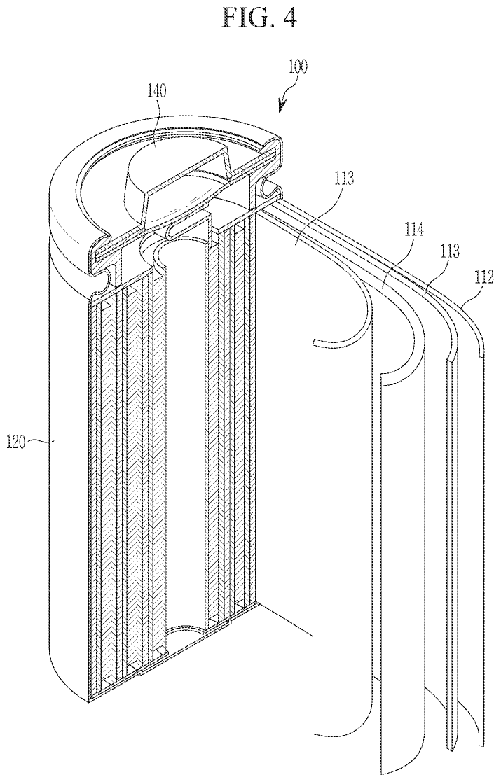

FIG. 4 is a schematic view illustrating a rechargeable lithium battery according to one or more embodiments of the present disclosure. Referring to FIG. 4, a rechargeable lithium battery 100 according to one or more embodiments may include a battery cell including a positive electrode 114, a negative electrode 112 facing the positive electrode 114, a separator 113 between the positive electrode 114 and the negative electrode 112, an electrolyte solution for a rechargeable lithium battery impregnating the positive electrode 114, negative electrode 112, and separator 113, a battery case 120 containing the battery cell, and a sealing member 140 sealing the battery case 120.

Hereinafter, descriptions overlapping with those described above will not be provided for conciseness, and elements constituting the rechargeable lithium battery will be described in more detail.

### Positive Electrode

The positive electrode may include a positive electrode current collector and a positive electrode active material layer on the positive electrode current collector, and the positive electrode active material layer may include a positive electrode active material.

The positive electrode active material may include one or more lithiated intercalation compounds that reversibly intercalate and deintercalate lithium ions.

For example, in one or more embodiments, the positive electrode active material may include one or more composite oxides of a metal selected from cobalt, manganese, nickel, and a combination thereof, and lithium. Such a positive electrode active material may be at least one of lithium composite oxides represented by Chemical Formula 5.

LiₓM¹_{y}M²_{z}M³_{1-y-z}O_{2±a}Xₐ Chemical Formula 5

In Chemical Formula 5,

0.5≤x≤1.8, 0≤a≤0.1, 0<y≤1, 0≤z≤1, 0<y+z≤1, M¹, M², and M³ may each independently be one or more elements selected from metals of nickel (Ni), cobalt (Co), manganese (Mn), aluminum (Al), boron (B), barium (Ba), calcium (Ca), cerium (Ce), chromium (Cr), iron (Fe), molybdenum (Mo), niobium (Nb), silicon (Si), strontium (Sr), magnesium (Mg), titanium (Ti), vanadium (V), tungsten (W), zirconium (Zr), lanthanum (La), and a combination thereof, and X may be one or more elements selected from fluorine (F), sulfur (S), phosphorus (P), and/or chlorine (Cl).

In one or more embodiments, the positive electrode active material corresponding to Chemical Formula 5 may be at least one selected from LiCoO₂, LiNiO₂, LiMnO₂, LiMn₂O₄, LiNiₐMn_{b}Co_{c}O₂ (a+b+c=1), LiNiₐMn_{b}Co_{c}Al_{d}O₂ (a+b+c+d=1), and LiNiₑCo_{f}Al_{g}O₂ (e+f+g=1).

In some embodiments, a material in which a part of the metal of the composite oxide is substituted with a metal other than another metal may be utilized, and a phosphate compound of the composite oxide, for example, at least one selected from LiFePO₄, LiCoPO₄, and LiMnPO₄, may be utilized. A material having a coating layer on the surface of the composite oxide may be utilized, or a mixture of the composite oxide and the composite oxide having a coating layer may be utilized. The coating layer may include at least one coating element compound selected from an oxide of a coating element, a hydroxide of a coating element, an oxyhydroxide of a coating element, an oxycarbonate of a coating element, and a hydroxy carbonate of a coating element. The compound for the coating layer may be amorphous or crystalline. The coating element included in the coating layer may include Mg, Al, Co, K, Na, Ca, Si, Ti, V, Sn, Ge, Ga, B, As, Zr, or a combination thereof. The coating layer may be disposed in a method having no adverse influence on properties of a positive electrode active material by utilizing these elements in the compound. For example, the method may include any coating method (e.g., spray coating, dipping, etc.), which is not illustrated in more detail herein because it is well-suitable to those skilled in the related field.

In one or more embodiments, a nickel-based positive electrode active material containing nickel may be utilized as the positive electrode active material. In these embodiments, in Chemical Formula 5, M¹ may be Ni. For example, in one or more embodiments, the cathode active material selected from LiNi_{b}Mn_{c}Co_{d}O₂ (b+c+d=1), LiNi_{b}Mn_{c}Co_{d}AlₑO₂ (b+c+d+e=1), and LiNi_{b}Co_{d}AlₑO₂ (b+d+e=1) is high nickel (high Ni)-based positive electrode active material.

In the embodiments of the LiNi_{b}Mn_{c}Co_{d}O₂ (b+c+d=1) and/or LiNi_{b}Mn_{c}Co_{d}AlₑO₂ (b+c+d+e=1), the nickel content (e.g., amount) may be greater than or equal to about 60% (b≥0.6), or greater than or equal to about 80% (b≥0.8). In the embodiments of the LiNi_{b}Co_{d}AlₑO₂ (b+d+e=1), the nickel content (e.g., amount) may be greater than or equal to about 60% (b≥0.6), or greater than or equal to about 80% (b≥0.8).

In some embodiments, as the positive electrode active material, a nickel-based cobalt-free positive electrode active material that contains nickel but does not contain cobalt may be utilized. In these embodiments, Chemical Formula 5 may be represented by Chemical Formula 5-1:

LiₓNi_{y}Mn_{(1-y)}O₂, Chemical Formula 5-1

wherein, 0.5≤x≤1.8, and 0<y<1.

In some embodiments, an amount of the positive electrode active material may be about 90 wt % to about 98 wt % based on a total weight of a positive electrode composition (e.g., the positive electrode active material layer).

Each amount of a conductive material and binder may be about 1 wt % to about 5 wt % based on a total weight of the positive electrode composition (e.g., the positive electrode active material layer).

The conductive material may be included to impart conductivity to the positive electrode, and any electrically conductive material may be utilized as a conductive material unless it causes a chemical change. Non-limiting examples of the conductive material may include a carbon-based material such as natural graphite, artificial graphite, carbon black, acetylene black, ketjen black, a carbon fiber, and/or the like; a metal-based material of a metal powder or a metal fiber including copper, nickel, aluminum, silver, and/or the like; a conductive polymer such as a polyphenylene derivative; or a mixture thereof.

The binder improves binding properties of positive electrode active material particles with one another and with the positive electrode current collector. Non-limiting examples thereof may include polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and/or the like, but embodiments of the present disclosure are not limited thereto.

In one or more embodiments, the positive electrode current collector may include Al, but embodiments of the present disclosure are not limited thereto.

### Negative Electrode

The negative electrode may include a negative electrode current collector and a negative electrode active material layer on the negative electrode current collector and including a negative electrode active material. According to one or more embodiments, the negative electrode may have a structure in which a negative electrode current collector, a negative electrode active material layer, a functional layer, and an adhesive layer are sequentially stacked.

The negative electrode active material may include a material that reversibly intercalates/deintercalates lithium ions, lithium metal, lithium metal alloy, material capable of doping and dedoping lithium, and/or a transition metal oxide.

The material that reversibly intercalates/deintercalates lithium ions may include, for example, crystalline carbon, amorphous carbon, or a combination thereof as a carbon-based negative electrode active material. The crystalline carbon may be irregular, or sheet, flake, spherical, or fiber shaped natural graphite or artificial graphite. The amorphous carbon may be a soft carbon, a hard carbon, a mesophase pitch carbonization product, calcined coke, and/or the like.

The lithium metal alloy may include an alloy of lithium and one or more metals selected from Na, K, Rb, Cs, Fr, Be, Mg, Ca, Sr, Si, Sb, Pb, In, Zn, Ba, Ra, Ge, Al, and Sn.

The material capable of doping/dedoping lithium may be a Si-based negative electrode active material or a Sn-based negative electrode active material. The Si-based negative electrode active material may include silicon, a silicon-carbon composite, SiOₓ (0<x<2), a Si-Q alloy (wherein Q may be an alkali metal, an alkaline-earth metal, a Group 13 element, a Group 14 element, a Group 15 element, a Group 16 element, a transition metal, a rare earth element, or a combination thereof, but not Si), and the Sn-based negative electrode active material may include Sn, SnO₂, Sn—R alloy (wherein R may be an alkali metal, an alkaline-earth metal, a Group 13 element, a Group 14 element, a Group 15 element, a Group 16 element, a transition metal, a rare earth element, or a combination thereof, but not Sn). In some embodiments, at least one of these materials may be mixed with SiO₂. The elements Q and R may each independently be selected from Mg, Ca, Sr, Ba, radium (Ra), scandium (Sc), yttrium (Y), Ti, Zr, hafnium (Hf), rutherfordium (Rf), V, Nb, tantalum (Ta), dubnium (Db), Cr, Mo, W, seaborgium (Sg), technetium (Tc), rhenium (Re), bohrium (Bh), Fe, Pb, ruthenium (Ru), osmium (Os), hassium (Hs), rhodium (Rh), iridium (Ir), palladium (Pd), platinum (Pt), Cu, silver (Ag), gold (Au), Zn, cadmium (Cd), B, Al, gallium (Ga), Sn, In, thallium (TI), Ge, P, arsenic (As), Sb, bismuth (Bi), S, selenium (Se), tellurium (Te), polonium (Po), and a combination thereof.

The silicon-carbon composite may be, for example, a silicon-carbon composite including a core including crystalline carbon and silicon particles and an amorphous carbon coating layer disposed on the surface of the core. The crystalline carbon may be artificial graphite, natural graphite, or a combination thereof. An amorphous carbon precursor may be a coal-based pitch, mesophase pitch, petroleum-based pitch, coal-based oil, petroleum-based heavy oil, or a polymer resin such as a phenol resin, a furan resin, or a polyimide resin. In one or more embodiments, a content (e.g., amount) of silicon (or Si or silicon particles) may be about 10 wt % to about 50 wt % based on a total weight of the silicon-carbon composite. In some embodiments, a content (e.g., amount) of the crystalline carbon may be about 10 wt % to about 70 wt % based on a total weight of the silicon-carbon composite, and a content (e.g., amount) of the amorphous carbon may be about 20 wt % to about 40 wt % based on a total weight of the silicon-carbon composite. In some embodiments, a thickness of the amorphous carbon coating layer may be about 5 nm to about 100 nm. An average particle diameter (D50) of the silicon particles may be about 10 nm to about 20 μm. The average particle diameter (D50) of the silicon particles may be desirably about 10 nm to about 200 nm. In some embodiments, the silicon particles may exist in an oxidized form, and in these embodiments, an atomic content (e.g., amount) ratio of Si:O in the silicon particles indicating a degree of oxidation may be a weight ratio of about 99:1 to about 33:66. In some embodiments, the silicon particles may be SiOₓ particles, and a range of x in SiOₓ may be greater than about 0 and less than about 2. As utilized herein, when a definition is not otherwise provided, an average particle diameter (D50) indicates a particle where an accumulated volume is about 50 volume % in a particle distribution.

In one or more embodiments, the Si-based negative electrode active material or Sn-based negative electrode active material may be mixed with the carbon-based negative electrode active material. If (e.g., when) the Si-based negative electrode active material or Sn-based negative electrode active material and the carbon-based negative electrode active material are mixed and utilized, a mixing ratio may be a weight ratio of about 1:99 to about 90:10.

In the negative electrode active material layer, the negative electrode active material may be included in an amount of about 95 wt % to about 99 wt % based on a total weight of the negative electrode active material layer.

In some embodiments, the negative electrode active material layer may further include a binder, and may optionally further include a conductive material. A content (e.g., amount) of the binder in the negative electrode active material layer may be about 1 wt % to about 5 wt % based on a total weight of the negative electrode active material layer. In some embodiments, if (e.g., when) the conductive material is further included, the negative electrode active material layer may include about 90 wt % to about 98 wt % of the negative electrode active material, about 1 wt % to about 5 wt % of the binder, and about 1 wt % to about 5 wt % of the conductive material.

The binder serves to well adhere the negative electrode active material particles to each other and also to adhere the negative electrode active material to the negative electrode current collector. The binder may be a water-insoluble binder, a water-soluble binder, or a combination thereof.

Non-limiting examples of the water-insoluble binder may include polyvinyl chloride, carboxylated polyvinyl chloride, polyvinyl fluoride, an ethylene oxide-containing polymer, an ethylene propylene copolymer, polystyrene, polyvinylpyrrolidone, polyurethane, polytetrafluoroethylene, polyvinylidene fluoride, polyethylene, polypropylene, polyamideimide, polyimide, or a combination thereof.

The water-soluble binder may include a rubber binder or a polymer resin binder. The rubber binder may be selected from a styrene-butadiene rubber, an acrylated styrene-butadiene rubber, an acrylonitrile-butadiene rubber, an acrylic rubber, a butyl rubber, a fluororubber, and a combination thereof. The polymer resin binder may be selected from polyethylene oxide, polyvinylpyrrolidone, polyepichlorohydrin, polyphosphazene, polyacrylonitrile, an ethylene propylene diene copolymer, polyvinylpyridine, chlorosulfonated polyethylene, latex, a polyester resin, an acrylic resin, a phenol resin, an epoxy resin, polyvinyl alcohol, and a combination thereof.

If (e.g., when) a water-soluble binder is utilized as the binder for the negative electrode, a cellulose-based compound capable of imparting viscosity may be further included. As the cellulose-based compound, one or more of carboxymethyl cellulose, hydroxypropylmethyl cellulose, methyl cellulose, or alkali metal salts thereof may be mixed and utilized. As the alkali metal, Na, K, or Li may be utilized. An amount of such a thickener utilized may be about 0.1 parts by weight to about 3 parts by weight based on 100 parts by weight of the negative electrode active material.

The conductive material may be included to provide electrode conductivity. Any electrically conductive material may be utilized as a conductive material unless it causes a chemical change. Non-limiting examples of the conductive material may include a carbon-based material such as natural graphite, artificial graphite, carbon black, acetylene black, ketjen black, a carbon fiber, carbon nanotube, and/or the like; a metal-based material of a metal powder or a metal fiber including copper, nickel, aluminum silver, and/or the like; a conductive polymer such as a polyphenylene derivative; or a mixture thereof.

The negative electrode current collector may include one selected from a copper foil, a nickel foil, a stainless steel foil, a titanium foil, a nickel foam, a copper foam, a polymer substrate coated with a conductive metal, and a combination thereof.

### Electrolyte Solution

The electrolyte solution may include a non-aqueous organic solvent and a lithium salt.

The non-aqueous organic solvent serves as a medium for transmitting ions taking part in the electrochemical reaction of a battery. The non-aqueous organic solvent may be a carbonate-based, ester-based, ether-based, ketone-based, or alcohol-based solvent, or aprotic solvent. The carbonate-based solvent may be dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and/or the like. The ester-based solvent may be methyl acetate, ethyl acetate, n-propyl acetate, dimethyl acetate, methyl propionate, ethyl propionate, γ-butyrolactone, decanolide, valerolactone, mevalonolactone, caprolactone, and/or the like. The ether-based solvent may be dibutyl ether, tetraglyme, diglyme, dimethoxyethane, 2-methyltetrahydrofuran, tetrahydrofuran, and/or the like. The ketone-based solvent may be cyclohexanone, and/or the like. The alcohol-based solvent may be ethyl alcohol, isopropyl alcohol, etc., and the aprotic solvent may be nitriles such as R—CN (where R is a C2 to C20 linear, branched, or cyclic hydrocarbon group and may include a double bond, an aromatic ring, or an ether bond), amides such as dimethylformamide, dioxolanes such as 1,3-dioxolane, sulfolanes, and/or the like.

The non-aqueous organic solvent may be utilized alone or in a mixture. If (e.g., when) the organic solvent is utilized in a mixture, a mixture ratio may be controlled or selected in accordance with a desirable battery performance.

In some embodiments, in the carbonate-based solvent, a mixture of a cyclic carbonate and a chain carbonate may be utilized. In these embodiments, if (e.g., when) the cyclic carbonate and the chain carbonate are mixed in a volume ratio of about 1:1 to about 1:9, the electrolyte may exhibit excellent or suitable performance.

In one or more embodiments, the non-aqueous organic solvent may further include an aromatic hydrocarbon-based organic solvent in addition to the carbonate-based solvent. The carbonate-based solvent and the aromatic hydrocarbon-based organic solvent may be mixed in a volume ratio of about 1:1 to about 30:1.

As the aromatic hydrocarbon-based solvent, an aromatic hydrocarbon-based compound represented by Chemical Formula I may be utilized.

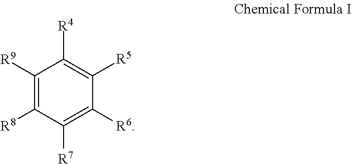

In Chemical Formula I, R⁴ to R⁹ may each independently be the same or different and may each independently be selected from hydrogen, a halogen, a C1 to C10 alkyl group, a haloalkyl group, and a combination thereof.

Non-limiting examples of the aromatic hydrocarbon-based solvent may be selected from benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, and a combination thereof.

In one or more embodiments, the electrolyte may further include vinylene carbonate or an ethylene carbonate-based compound of Chemical Formula II, as an additive, in order to improve cycle-life of a battery.

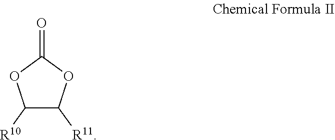

In Chemical Formula II, R¹⁰ and R¹¹ may each independently be the same or different, and may be each independently selected from hydrogen, a halogen, a cyano group, a nitro group, and a fluorinated C1 to C5 alkyl group, provided that at least one of R¹⁰ or R¹¹ is selected from a halogen, a cyano group, a nitro group, and a fluorinated C1 to C5 alkyl group, and both of R¹⁰ and R¹¹ (e.g., they simultaneously) are not hydrogen.

Non-limiting examples of the ethylene-based carbonate-based compound may be difluoro ethylenecarbonate, chloroethylene carbonate, dichloroethylene carbonate, bromoethylene carbonate, dibromoethylene carbonate, nitroethylene carbonate, cyanoethylene carbonate, and/or fluoroethylene carbonate. An amount of the additive for improving cycle-life may be utilized within an appropriate or suitable range.

The lithium salt dissolved in the non-organic solvent supplies lithium ions in a battery, enables a basic operation of a rechargeable lithium battery, and improves transportation of the lithium ions between positive and negative electrodes.

Non-limiting examples of the lithium salt may include at least one selected from LiPF₆, LiBF₄, LiSbF₆, LiASF₆, LiN(SO₂C₂F₅)₂, Li(CF₃SO₂)₂N, LIN(SO₃C₂F₅)₂, Li(FSO₂)₂N (lithium bis(fluorosulfonyl)imide; LiFSI), LiC₄F₉SO₃, LiClO₄, LiAlO₂, LiAlCl₄, LiPO₂F₂, LiN(CₓF₂ₓ₊₁SO₂)(C_{y}F_{2y+1}SO₂) (wherein x and y are natural numbers, for example, an integer in a range of 1 to 20), lithium difluoro(bisoxolato) phosphate, LiCl, LiI, LiB(C₂O₄)₂ (lithium bis(oxalato) borate; LiBOB), and lithium difluoro(oxalato)borate (LiDFOB).

The lithium salt may be utilized in a concentration in a range of about 0.1 M to about 2.0 M. If (e.g., when) the lithium salt is included at the above concentration range, the electrolyte solution may have excellent or suitable performance and lithium ion mobility due to optimal or suitable conductivity and viscosity of the electrolyte solution.

### Separator

The separator 113 may be any generally-utilized separator in a rechargeable lithium battery which may separate the positive electrode 114 and the negative electrode 112 and provide a transporting passage for lithium ions.

For example, it may have low resistance to ion transport and excellent or suitable impregnation for an electrolyte solution. For example, in one or more embodiments, the separator may be selected from a glass fiber, polyester, Teflon, polyethylene, polypropylene, polytetrafluoroethylene, or a combination thereof. In some embodiments, the separator may have a form of a non-woven fabric or a woven fabric. For example, in some embodiments, in a lithium ion battery, a polyolefin-based polymer separator such as polyethylene and polypropylene may be mainly utilized. In order to ensure the heat resistance or mechanical strength, a coated separator including a ceramic component or a polymer material may be utilized. In some embodiments, it may have a mono-layered or multi-layered structure.

Rechargeable lithium batteries may be classified as lithium ion batteries, lithium ion polymer batteries, or lithium polymer batteries according to the presence of a separator and the type or kind of electrolyte solution utilized therein. The rechargeable lithium batteries may have a variety of shapes and sizes, and may include cylindrical, prismatic, coin, or pouch-type or kind batteries, and may be thin film batteries or may be rather bulky in size. Because the structure and manufacturing method of these batteries are well suitable in the art, a detailed description thereof will not be provided for conciseness.

Hereinafter, examples of the present disclosure and comparative examples are described. It is to be understood, however, that the examples are for the purpose of illustration and are not to be construed as limiting the present disclosure.

### PREPARATION EXAMPLES

### Preparation Example 1: Preparation of Base Layer

2-hydroxyethyl acrylate (2-HEA) as a first compound, isobornyl acrylate (IBOA) as a second compound, and phenoxyethyl acrylate as a third compound were utilized.

A first mixture was prepared by mixing the above compounds in a weight ratio of first compound: second compound: third compound=35:55:10, and 0.1 part by weight of a first initiator (2,2-dimethoxy-1,2-diphenylethan-1-one) (Iracure 651) was added based on 100 parts by weight of the first mixture. Then, ultraviolet (UV) light was irradiated at an intensity of 300 mJ/cm² to prepare a latex-type of the first (meth)acrylic copolymer having a solid content (e.g., amount) of 4 wt %.

A second mixture was prepared by further mixing 0.4 parts by weight of a second initiator (Iracure 651) and 0.2 parts by weight of a curing agent (tetra(ethylene glycol) diacrylate) based on 100 parts by weight of the first (meth)acrylic copolymer. The second mixture was coated on the first polyethylene terephthalate (PET) film to a thickness of 40 μm, the second PET film was placed thereon, and the second mixture was cured by irradiating UV with an intensity of 3000 mJ/cm² to obtain a base layer.

### Preparation Example 2: Preparation of Base Layer

As in Preparation Example 1, 2-hydroxyethyl acrylate (2-HEA) as the first compound, isobornyl acrylate (IBOA) as the second compound, and the phenoxyethyl acrylate as the third compound were utilized.

A first mixture was prepared by mixing the above compounds in a weight ratio of first compound: second compound: third compound=35:55:10, and 0.1 part by weight of an initiator (Iracure 651) was added based on 100 parts by weight of the first mixture. After adding 0.05 parts by weight of a curing agent (tetra(ethylene glycol) diacrylate), partial polymerization was performed at 65° C. for 5 minutes to prepare a resin.

A second mixture was prepared by mixing 0.4 parts by weight of an initiator (Iracure 651) and 0.2 parts by weight of a curing agent (tetra(ethylene glycol) diacrylate) based on 100 parts by weight of the prepared resin. The second mixture was coated on the first PET film to a thickness of 40 μm, the second PET film was placed thereon, and the second mixture was cured by irradiating ultraviolet (UV) light with an intensity of 3000 mJ/cm² to obtain a base layer.

### Preparation Example 3: Preparation of Adhesive Layer

As the fourth compound, 2-hydroxyethyl acrylate (2-HEA) and 4-hydroxybutyl acrylate (4-HBA) were used.

A third mixture was prepared by adding the above compounds in a weight ratio of 2-hydroxyethyl acrylate: 4-hydroxybutyl acrylate=85:15 to a four-necked flask equipped with a stirring blade, a thermometer, a nitrogen gas inlet tube, and a condenser. And, based on 100 parts by weight of the third mixture, 0.1 parts by weight of a thermal initiator (2,2′-azobisisobutyronitrile) was added with 85 parts by weight of ethyl acetate and 15 parts by weight of toluene to prepare a fourth mixture.

After introducing nitrogen gas while gently stirring the fourth mixture and substituting it with nitrogen, the liquid temperature in the flask was maintained at around 55° C. A solution containing a copolymer (Mw 1,300,000 g/mol, Mw/Mn=1.7) was prepared.

A fifth mixture was prepared by adding/mixing 0.3 parts by weight of trimethylolpropane-xylylene diisocyanate (TMP-XDI, product name: Takenate D110N, manufacturer: Mitsui Chemicals) and 0.1 parts by weight of a silane-based coupling agent (KBM-403) therein. The fifth mixture was applied to one side of a PET film (separator film: SKC Haas, manufacturer: Mitsubishi Chemical Co., Ltd., MRF38) treated with a silicone-based release agent, dried at 135° C. for 4 minutes, separated from the PET film, and then an adhesive layer having a thickness of 10 μm was obtained.

### Preparation Example 4: Preparation of Adhesive Layer

An adhesive layer was prepared in the same manner as in Preparation Example 3, except that the amount of trimethylolpropane-xylene diisocyanate used as the isocyanate compound was changed to 0.5 parts by weight.

### Preparation Example 5: Preparation of Adhesive Layer

A solution containing the second acrylic copolymer was prepared in the same manner as in Preparation Example 3. With respect to 100 parts by weight of the solid content of the solution containing the second acrylic copolymer, a sixth mixture was prepared by adding 2 parts by weight of tris [2-(acryloyloxy) ethyl] isocyanurate (product name: ARONIX M-315, manufacturer: Toagosei) and 0.2 parts by weight of a third photoinitiator (Iracure 651) thereto. The sixth mixture was applied to one side of a PET film (separator film: SKC Haas, manufacturer: Mitsubishi Chemical Co., Ltd., MRF38) treated with a silicone-based release agent, dried at 135° C. for 4 minutes, and then an adhesive layer was obtained by irradiating with ultraviolet (UV) light.

### Examples and Comparative Examples

### Example 1

### 1. Manufacture of Sealing Tapes

On one surface of the base layer of Preparation Example 1, the adhesive layer of Preparation Example 3 was attached.

As a result, an adhesive layer having a thickness of 10 μm and a peel force of 650 gf/25 mm with respect to the glass plate was formed, and the sealing tape of Example 1 was obtained. Herein, the peel force with respect to the glass plate was evaluated by Evaluation Example 2 described later.

### 2. Manufacture of Electrode Assembly and Battery Cell

LiNi_{0.91}Co_{0.04}Al_{0.05}O₂ as a positive electrode active material, polyvinylidene fluoride as a binder, and ketjen black as a conductive material were mixed in a weight ratio of 98.5:0.75:0.75 and then, dispersed in N-methyl pyrrolidone, preparing positive electrode active material slurry.

The positive electrode active material slurry was coated on a 14 μm-thick Al foil, dried at 110° C., and roll-pressed, manufacturing a positive electrode.

Negative electrode active material slurry was prepared by utilizing a mixture of artificial graphite as a negative electrode active material and silicon particles in a weight ratio of 93.5:6.5 as a negative electrode active material, mixing the negative electrode active material, styrene-butadiene rubber as a binder, and carboxylmethyl cellulose in a weight ratio of 97:1:2, and then, dispersing the obtained mixture in distilled water.

The negative electrode active material slurry was coated on a 10 μm-thick Cu foil, dried at 100° C., and then, roll-pressed, manufacturing a negative electrode.

After stacking the positive electrode, a separator, and the negative electrode, winding the stack into a jelly roll-type or kind electrode assembly (cross-section diameter: 21 mm), and attaching the sealing tape of Example 1 to cover 50% of an outer circumferential surface area of the jelly roll-type or kind electrode assembly, the jelly roll-type or kind electrode assembly was inserted into a cylindrical can (cross-section diameter: 21 mm). Subsequently, after injecting a carbonate-based electrolyte solution into the cylindrical can, the cylindrical can was sealed, completing a battery cell.

As the electrolyte solution, 1.1 M LiPF₆ was dissolved in a mixed solvent of ethylene carbonate (EC), dimethyl carbonate (DMC), propylene carbonate (PC), and fluorobenzene (FB) which were mixed in a volume ratio of EC:DMC:PC:FB=30:55:5:10.

### Example 2

On one surface of the base layer of Preparation Example 1, the adhesive layer of Preparation Example 4 was attached.

As a result, an adhesive layer having a thickness of 10 μm and a peel force of 450 gf/25 mm with respect to the glass plate was formed. A sealing tape, an electrode assembly, and a battery cell of Example 2 were obtained in substantially the same manner as in Example 1 except for this point (i.e., the sealing tape).

### Example 3

On one surface of the base layer of Preparation Example 2, the adhesive layer of Preparation Example 3 was attached.

As a result, an adhesive layer having a thickness of 10 μm and a peel force of 550 gf/25 mm with respect to the glass plate was formed. A sealing tape, an electrode assembly, and a battery cell of Example 3 were obtained in substantially the same manner as in Example 1 except for this point (i.e., the sealing tape).

### Example 4

On one surface of the base layer of Preparation Example 2, the adhesive layer of Preparation Example 5 was attached.

Accordingly, an adhesive layer having a thickness of 10 μm and a peel force of 550 gf/25 mm with respect to the glass plate was formed. A sealing tape, an electrode assembly, and a battery of Example 4 were obtained in the same manner as in Example 1 except for this point (i.e., the sealing tape).

### Comparative Example 1

On one surface of a PET base layer, the adhesive layer of Preparation Example 4 was attached.

As a result, an adhesive layer having a peel force of 250 gf/25 mm and a thickness of 10 μm was formed. A sealing tape, an electrode assembly, and a battery cell of Comparative Example 1 were obtained in substantially the same manner as in Example 1 except for this point (i.e., the sealing tape).

### Comparative Example 2

On one surface of a polypropylene (PP) base layer, the adhesive layer of Preparation Example 4 was attached.

As a result, an adhesive layer having a peel force of 400 gf/25 mm and a thickness of 10 μm was formed. A sealing tape, an electrode assembly, and a battery cell of Comparative Example 2 were obtained in substantially the same manner as in Example 1 except for this point (i.e., the sealing tape).

### Evaluation Examples

Physical properties in Examples and Comparative Examples were each evaluated in the following manner, and the evaluation results are shown in Table 1.

### Evaluation Example 1: Strain Rate of Base Layer

In order to measure the strain rates of the base layers, specimens were each prepared by cutting each base layer of Examples and Comparative Examples so that width*length=10 mm*10 mm.

The specimens were each immersed in a carbonate-based electrolyte solution, allowed to stand for 1 day after being sealed at room temperature, and taken from the electrolyte solution and then, measured with respect to a length in a vertical direction of each specimen. Each measurement was put into Equations 1-1 and 1-2 to evaluate the strain rates.

As the electrolyte solution, 1.1 M LiPF₆ was dissolved in a mixed solvent of ethylene carbonate (EC), dimethyl carbonate (DMC), propylene carbonate (PC) and fluorobenzene (FB), and a volume ratio of the mixed solvent was EC:DMC:PC:FB=30:55:5:10.

$$Equation 1 - 1$$

$$Strain rate in a longitudinal direction = ( L 2 - L 1 ) / L 1 \times 100$$

In Equation 1-1,

L1 is a longitudinal length of the specimen measured before impregnation with the electrolyte solution, that is, 10 mm, and

L2 is a longitudinal length of the specimen measured after impregnation with the electrolyte solution.

$$Strain rate in a width direction = ( W 2 - W 1 ) / W 1 \times 100 \qquad Equation 1 - 2$$

In Equation 1-3,

W1 is a length in a transverse direction of the specimen measured before impregnation with an electrolyte solution, that is, 10 mm, and

W2 is a length in a transverse direction of the specimen measured after impregnation with the electrolyte solution.

### Evaluation Example 2: Peel Force of Adhesive Layer

In order to measure the peel force of the adhesive layer, specimens were each manufactured by cutting each of the sealing tapes of Examples and Comparative Examples into a size of 25 mm×200 mm (width×length). After attaching an adhesive layer side of each of the specimens to a glass plate with a 2 kg rubber roller, the specimen was stored at room temperature for 2 hours. Subsequently, the adhesive layer was measured with respect to a peel force at a peeling speed of 5 mm/sec at a peeling angle of 180° by utilizing a tensile tester.

### Evaluation Example 3: Shear Strength of Adhesive Layer

Each sealing tape specimen (width*length=10 cm*10 cm) of the examples and the comparative examples was manufactured according to KS M3734 and then, measured with respect to shear strength of an adhesive layer of the specimen by stretching the specimen at 10 mm/min with a universal tester (TO-102, TEST ONE).

### Evaluation Example 4: Three-dimensional Shape Realization Ability of Sealing Tape

Each sealing tape specimen was evaluated with respect to three-dimensional shape realization ability by storing each cell of the examples and the comparative examples at room temperature for one day and disassembling it to take an electrode assembly and then, examining a state of the sealing tape attached to the electrode assembly. For example, the state of the sealing tape was evaluated with respect to the three-dimensional shape realization ability according to the following criteria and three-dimensional shapes shown in FIG. 2.

O: a three-dimensional shape of a sealing tape was observed

Δ: no three-dimensional shape of a sealing tape was observed

X: no three-dimensional shape of a sealing tape was observed, and the sealing tape was peeled off from an electrode assembly

### Evaluation Example 5: Gap Filling Ability of Sealing Tape (Flow Prevention Ability of Electrode Assembly)

Each sealing tape was evaluated with respect to gap filling ability in a method of evaluating anti-flow ability of an electrode assembly, and the anti-flow ability of an electrode assembly is evaluated in a residual vibration evaluation method and a residual impact evaluation method.

The residual vibration evaluation method is performed by a vibration test of UN38.3, wherein if (e.g., when) a cell became power insensitive after the evaluation, it is judged as a disconnection of one terminal.

On the other hand, the residual impact evaluation method is performed by placing a cell in an octagonal cylinder, rotating it to check whether or not the cell becomes power insensitive after a set or predetermined period, and judging it as a disconnection of a terminal if (e.g., when) the cell became power insensitive.

Each cell of the examples and the comparative examples were evaluated in both (e.g., simultaneously) of the methods, from which the sealing tapes were finally evaluated with respect to gap filling ability (flow prevention ability of electrode assembly) according to the following criteria.

O: battery power was measured after the residual vibration evaluation method and the residual impact evaluation method

Δ: battery power was measured after the residual vibration evaluation method and the residual impact evaluation method, but resistance increases by 10% or more

X: no battery power was measured after the residual vibration evaluation method or the residual impact evaluation method

TABLE 1

| | | | | | | Comparative | |
|---|---|---|---|---|---|---|---|
| | | Examples | | | | Examples | |
| Evaluation factor | | 1 | 2 | 3 | 4 | 1 | 2 |
| Base | Type | acrylic | acrylic | acrylic | acrylic | PET | PP |
| layer | Strain | 50% | 55% | 60% | 40 | 0% | 0% |
| | rate (L) | | | | | | |
| | Strain | 40% | 25% | 30% | 20 | 0% | 0% |
| | rate (W) | | | | | | |
| Adhesive | Composition | acrylic | acrylic | acrylic | acrylic | acrylic | acrylic |
| layer | Peel | 650 gf/25 | 450 gf/25 | 550 gf/25 | 300 gf/25 | 250 gf/25 | 400 gf/25 |
| | force | mm | mm | mm | mm | mm | mm |
| | Shear | 12 kgf | 12 kgf | 12 kgf | 14 kgf | 12 kgf | 12 kgf |
| | strength | | | | | | |

| | | | | | | |
|---|---|---|---|---|---|---|
| Three-dimensional | ◯ | ◯ | ◯ | ◯ | X | X |
| shape realization ability | | | | | | |
| Gap filling ability | ◯ | ◯ | ◯ | ◯ | X | X |

### Comprehensive Evaluation Results

Referring to Evaluation Examples 1 to 5, each of the sealing tapes according to one or more embodiments, represented by Examples 1 to 4, if (e.g., when) in contact with a fluid such as a liquid, turned out to realize a three-dimensional shape capable of filling a gap due to mutual balance between a force generated as a base layer expands and a fixing force of an adhesive layer.

For example, the sealing tape according to one or more embodiments overcomes decrease in adhesion strength over time and an isotropic volume change of the electrode assembly due to substantially continuous charging and discharging, and/or the like, and thereby, even when internal/external vibration or shock occurs, it may suppress or reduce the jelly roll-type or kind electrode assembly from flowing inside the cylindrical battery case.

Accordingly, in the rechargeable lithium battery in which the sealing tape according to one or more embodiments is applied to the gap between the cylindrical battery case and the jelly roll electrode assembly, an increase in internal resistance, damage to the electrode tab, etc. are suppressed or reduced, and excellent or suitable performance may be maintained.

In the present disclosure, “or” is not to be construed as an exclusive meaning, for example, “A or B” is construed to include A, B, A+B, and/or the like. Further, as used herein, the term “and/or” includes any and all combinations of one or more of the associated listed items. The “/” utilized herein may be interpreted as “and” or as “or” depending on the situation. Expressions such as “at least one of,” “one of,” and “selected from,” when preceding a list of elements, modify the entire list of elements and do not modify the individual elements of the list. For example, “at least one of a, b, or c”, “at least one of a, b, and/or c”, “at least one selected from a, b, and c”, “at least one selected from among a to c”, etc. may indicate only a, only b, only c, both (e.g., simultaneously) a and b, both (e.g., simultaneously) a and c, both (e.g., simultaneously) b and c, all of a, b, and c, or variations thereof.

In the present disclosure, although the terms “first,” “second,” etc., may be utilized herein to describe one or more elements, components, regions, and/or layers, these elements, components, regions, and/or layers should not be limited by these terms. These terms are only utilized to distinguish one component from another component.

As utilized herein, the singular forms “a,” “an,” and “the” are intended to include the plural forms as well, unless the context clearly indicates otherwise. Further, the utilization of “may” when describing embodiments of the present disclosure refers to “one or more embodiments of the present disclosure”.

As utilized herein, the term “substantially,” “about,” and similar terms are utilized as terms of approximation and not as terms of degree, and are intended to account for the inherent deviations in measured or calculated values that would be recognized by those of ordinary skill in the art. “About” or “approximately,” as utilized herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within +30%, 20%, 10%, 5% of the stated value.

Also, any numerical range recited herein is intended to include all subranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

In the present disclosure, when the electrode active material particles are spherical, “size” or “diameter” indicates a particle diameter or an average particle diameter, and when the particles are non-spherical, the “size” or “diameter” indicates a major axis length or an average major axis length. That is, when particles are spherical, “diameter” indicates a particle diameter, and when the particles are non-spherical, the “diameter” indicates a major axis length. The size or diameter of the particles may be measured utilizing a scanning electron microscope or a particle size analyzer. As the particle size analyzer, for example, HORIBA, LA-950 laser particle size analyzer, may be utilized. When the size of the particles is measured utilizing a particle size analyzer, the average particle diameter (or size) is referred to as D50. D50 refers to the average diameter (or size) of particles whose cumulative volume corresponds to 50 vol % in the particle size distribution (e.g., cumulative distribution), and refers to the value of the particle size corresponding to 50% from the smallest particle when the total number of particles is 100% in the distribution curve accumulated in the order of the smallest particle size to the largest particle size.

While the present disclosure has been described in connection with what is presently considered to be practical example embodiments, it is to be understood that the present disclosure is not limited to the disclosed embodiments. In contrast, it is intended to cover one or more suitable modifications and equivalent arrangements included within the spirit and scope of the appended claims and equivalents thereof.

### REFERENCE NUMERALS

1, 1′: (meth)acrylic copolymer
2: crosslinking agent
100: rechargeable lithium battery
112: negative electrode
113: separator
114: positive electrode
120: battery case
140: sealing member
200: sealing tape
210: adhesive layer
220: base layer
300: semi-interpenetrating polymer network (semi-IPN) structure

What is claimed is:

1. A sealing tape for a rechargeable lithium battery, the sealing tape comprising:
a base layer and an adhesive layer on at least one surface of the base layer,
wherein:
the base layer comprises a first (meth)acrylic copolymer;
the first (meth)acrylic copolymer comprises:
a moiety derived from a first (meth)acrylate-based compound having a substituted or unsubstituted C1 to C20 alkyl group;
a moiety derived from a second (meth)acrylate-based compound having a substituted or unsubstituted C3 to C20 cycloalkyl group; and
a moiety derived from a third (meth)acrylate-based compound having a C1 to C20 alkyl group substituted with a phenoxy group;
the adhesive layer comprises a second (meth)acrylic copolymer and a crosslinking agent; and
the second (meth)acrylic copolymer comprises:
a moiety derived from a fourth (meth)acrylate-based compound having a substituted or unsubstituted C1 to C20 alkyl group.

2. The sealing tape as claimed in claim 1, wherein
the first (meth)acrylate-based compound and the fourth (meth)acrylate-based compound are each independently
2-hydroxyethyl (meth)acrylate, 2-hydroxypropyl (meth)acrylate, 4-hydroxybutyl (meth)acrylate, 2-ethylhexyl (meth)acrylate, methyl (meth)acrylate, ethyl (meth)acrylate, propyl (meth)acrylate, butyl (meth)acrylate, pentyl (meth)acrylate, hexyl (meth)acrylate, heptyl (meth)acrylate, octyl (meth)acrylate, nonyl (meth)acrylate, decyl (meth)acrylate, dodecyl (meth)acrylate, lauryl (meth)acrylate, or a combination thereof.

3. The sealing tape as claimed in claim 1, wherein
the second (meth)acrylate-based compound is
isobornyl (meth)acrylate, bornyl (meth)acrylate, cyclohexyl (meth)acrylate, or a combination thereof.

4. The sealing tape as claimed in claim 1, wherein
the third (meth)acrylate-based compound is phenoxyethyl acrylate.

5. The sealing tape as claimed in claim 1, wherein
the crosslinking agent is an isocyanate-based compound, an isocyanurate-based compound, or a combination thereof.

6. The sealing tape as claimed in claim 1, wherein
the first (meth)acrylic copolymer comprises:
based on a total amount of 100 wt % of the first (meth)acrylic copolymer,
about 20 to about 50 wt % of the moiety derived from the first (meth)acrylate-based compound;
about 30 to about 70 wt % of the moiety derived from the second (meth)acrylate-based compound; and
about 0.1 to about 20 wt % of the moiety derived from the third (meth)acrylate-based compound.

7. The sealing tape as claimed in claim 1, wherein
the base layer has
a strain rate, according to Equation 1, of about 50 to about 150% when impregnated with an electrolyte solution at 25° C. for 120 minutes or more and 1 day or less, and
the electrolyte solution has a composition in which 1.1 M LiPF₆ dissolved in a solvent of ethylene carbonate (EC), dimethyl carbonate (DMC), propylene carbonate (PC), and fluorobenzene (FB) in a volume ratio of EC:DMC:PC:FB=30:55:5:10:
$$( B - A ) / A , \qquad Equation 1$$
wherein, in Equation 1,
A is a length in a specific direction of the base layer before impregnation with the electrolyte solution; and
B is a length in the specific direction of the base layer after impregnation with the electrolyte solution.

8. The sealing tape as claimed in claim 1, wherein
the base layer further comprises a polyethylene terephthalate (PET) film.

9. The sealing tape as claimed in claim 8, wherein
the base layer comprises:
a first base layer comprising a first PET film;
a second base layer comprising the first (meth)acrylic copolymer; and
a third base layer comprising a second PET film,
which are sequentially stacked.

10. The sealing tape as claimed in claim 1, wherein
in the adhesive layer, an amount of the crosslinking agent is about 0.01 to about 5 parts by weight based on 100 parts by weight of the second (meth)acrylic copolymer.

11. The sealing tape as claimed in claim 1, wherein
in the adhesive layer, the second (meth)acrylic copolymer is crosslinked by the crosslinking agent to form a polymer having a semi-interpenetrating polymer network (semi-IPN) structure.

12. The sealing tape as claimed in claim 11, wherein
the adhesive layer comprises:
the polymer having a semi-interpenetrating polymer network (semi-IPN) structure formed by crosslinking the second (meth)acrylic copolymer with the crosslinking agent; and
a linear polymer comprising the second (meth)acrylic copolymer, independently of the polymer having a semi-interpenetrating polymer network (semi-IPN) structure.

13. The sealing tape as claimed in claim 1, wherein
a thickness of the adhesive layer is about 5 μm to about 150 μm.

14. A rechargeable lithium battery, comprising:
an electrode assembly;
an electrolyte solution impregnated in the electrode assembly;
a battery case accommodating the electrode assembly; and
the sealing tape as claimed in claim 1 in a gap between the battery case and the electrode assembly.
